(19) United States
(12) Patent Application Publication
(10) Pub. No.: US 2026/0338096 A1
(43) Pub. Date: Oct. 29, 2026

(54) Combined Heat and Power System Using and Producing CO and Method of Operation

(71) Applicant: Enexor Energy, LLC, Franklin, TN (US)

(72) Inventor: Ricardo Conde, New Salem, MA (US)

(21) Appl. No.: 19/661,023

(22) Filed: Apr. 28, 2026

Related U.S. Application Data
(60) Provisional application No. 63/985,517, filed on Feb. 18, 2026.
(60) Provisional application No. 63/834,414, filed on Apr. 29, 2025.

(51) Int. Cl. F01N 5/04; F01N 5/02; F02B 37/00; F02B 41/00

(52) U.S. Cl. CPC F01N 5/04; F01N 5/02; F02B 37/005; F02B 41/00; F01N 2240/02

(57) ABSTRACT

A combined heat and power system is disclosed, comprising a combustor for receiving and combusting a fuel and gas mixture, which outputs combustion gas via a first outlet. The system includes a filter box with a first inlet fluidly connected to the combustor's outlet. The filter box contains at least one filter member and a mixing plenum connected to the filter member, and has a second outlet. An expansion turbine, coupled to the filter box's second outlet, utilizes filtered gas to generate work by expanding the gas, releasing lower pressure gas through a third outlet. A recuperator, connected to the turbine's outlet, facilitates thermal energy transfer from the lower pressure gas to a CO2 stream. Subsequently, one or more heat exchangers reduce the CO2 stream temperature. A compressor, coupled to the turbine, compresses the CO2 stream and returns it to the filter box via a sixth outlet.

### CROSS-REFERENCE TO RELATED APPLICATIONS

The present application is a nonprovisional application of, and claims the benefit of, United States Provisional Application Serial No. 63/834,414 filed on Apr. 29, 2025 entitled “COMBINED HEAT AND POWER SYSTEM USING AND PRODUCING CO₂ AND METHOD OF OPERATION” and United States Provisional Application Serial No. 63/985,517 filed on Feb. 18, 2026 entitled “COMBINED HEAT AND POWER SYSTEM USING AND PRODUCING CO₂ AND METHOD OF OPERATION”, the contents of both of which are incorporated by reference herein.

### TECHNICAL FIELD

The subject matter described herein relates to a combined heat and power system, in particular to a thermal system utilizing waste organic resources and converting it into heat energy used to drive a gas turbine to produce electrical power and a high level of usable waste heat for both low and high temperature thermal applications. The combined heat and power system is also configured to produce carbon dioxide (CO2) gas at a high level of concentration.

### BACKGROUND

Combined heat and power (CHP) systems have been utilized in many forms for over 100 years. The most common are fossil fuel-fired systems that use, for example, steam turbines, gas-fired turbines, and internal combustion engines to produce electrical power. The rejected heat from these systems can be used for a wide range of applications such as heating, cooling, in industrial processes, and, in some cases where the waste heat temperature is high enough, to drive a second thermodynamic cycle. Most of the focus for traditional CHP systems has been on large fossil fuel-fired systems connected to district heating systems. Over the past 30 years, the focus has moved to smaller distributed CHP systems where the heat or power generated could be better utilized by the end user. These systems have also been fossil fuel-fired systems that commonly use small gas turbines or reciprocating engines to produce power along with usable waste heat from the cycle. Other systems that use the Organic Rankine Cycle have also been used, although the quality of the waste heat is relatively low, which limits the applications for use of the generated heat.

More recently, there has been a desire to use renewable organic waste streams for fuel. Large biomass and municipal solid waste-to-power systems have been in operation for many decades. The ability to utilize a wide variety of organic sources in a small CHP system (for example, less than 1 MW electric) has been challenging for several reasons (Potential Problem we talked about that the issue has been known in the field). There have been many small organic-to-power conversion technologies that have been utilized to varying degrees of success. Gasification of organics into a synthesis gas (“syngas”) has been one approach to convert a solid fuel into hydrocarbon gases for combustion in traditional power systems. Unfortunately, these systems can be costly, especially when scaled to smaller power/heat applications. In addition, organic feedstocks can present challenges in application. For example, depending on the gasification method and conversion efficiencies, the potential energy available in some organic materials suffers from losses that have an economic impact on the cost of power and heat. Gasification of mixed organic residues may be particularly problematic for many gasification systems.

Another method applied for small CHP applications has been to use direct combustion of organics through an appropriate combustor and to use the heat through a heat exchanger to drive an externally fired engine. Traditional externally fired systems include Stirling cycle, Steam Rankine, Organic Rankine, and supercritical CO2 cycles. In all these systems, the temperature of the rejected heat affects the cycle efficiency. The higher the reject heat temperature, the lower the power efficiency. Except for the steam cycle, the other thermodynamic cycles typically lose efficiency when producing even hot water at 90° C. However, with the steam cycle, the deficiency is the complexity and cost associated with a high-pressure steam circuit in a small application.

Another method that has been employed is to use an open Brayton cycle gas turbine and introduce heat indirectly through a heat exchanger. Several systems have been tested where a small turbine has been coupled to an organic combustion system. In these systems, ambient air is compressed in the compressor of the turbine and then directed to a recuperator to heat the compressor air. The compressed air is heated by the organic combustion system. The highly heated air is then expanded in the expansion turbine to produce work to turn a generator and generate electricity. Continuing the cycle, the hot turbine air is used for combustion air. The combustion exhaust gases may then be exhausted or directed to a further heat exchanger where usable waste heat can be extracted.

In some instances, there has also been a focus on reducing, capturing, and sequestering carbon dioxide (CO2) from power plant emissions. There are several methods to extract CO2 from exhaust gases, including adsorption, membrane, cryogenic, and electrochemical methods. Each of these systems represents a significant capital cost in addition to the energy consumption to capture CO2 from the exhaust gas.

Another method to extract CO2 from the exhaust gas is to use an oxygen-fuel (“oxy-fuel”) combustion system. In this system, oxygen is separated from air and used to oxidize the solid organic hydrocarbon, producing mostly CO2 and water. Oxy-fuel systems are used in the glass, steel, and ceramic industries to eliminate nitrous oxide (NOx) associated with high-temperature furnaces. Few oxy-fuel power systems have been developed, notably the Allam cycle, which uses an oxy-fuel burner with gaseous or liquid fuels in a supercritical CO2 cycle. Oxy-fuel systems have not been introduced to handle solid organic materials such as biomass, plastics, and other organic residues. The disadvantage of supercritical CO2 cycles is that the gaseous or liquid fuel needs to be compressed to very high pressures, up to 6000 PSI, to then inject into the combustor. It is very difficult to deliver solid fuels at the pressures needed in supercritical CO2 cycles.

Accordingly, while existing CHP systems are suitable for their intended purpose, the need for improvement remains, particularly in providing a CHP system having the features described herein.

### BRIEF SUMMARY

According to one aspect of the disclosure, a combined heat and power system is provided, comprising a combustor configured to receive and combust a fuel and gas mixture, the combustor having a first outlet that flows combustion gas from the combustor. A filter box having a first inlet fluidly coupled to the first outlet, the filter box having at least one filter member fluidly coupled to the first inlet and a mixing plenum fluidly coupled to the at least one filter member opposite the first inlet, the filter box having a second outlet. An expansion turbine having a second inlet fluidly coupled to the second outlet, the expansion turbine being configured to receive a flow of filtered gas from the filter box and generate work based at least in part on an expansion of the filtered gas and output a lower pressure gas through a third outlet. A recuperator fluidly coupled to the third outlet, the recuperator being configured to transfer thermal energy from the lower pressure gas from the expansion turbine to a carbon dioxide (CO2) gas stream, the recuperator having a fourth outlet. At least one heat exchanger fluidly coupled to the fourth outlet, the at least one heat exchanger being configured to reduce the temperature of the CO2 gas stream received from the recuperator and output a lower temperature CO2 gas stream through a fifth outlet.A compressor rotationally coupled to the expansion turbine, the compressor having a third inlet fluidly coupled to the fifth outlet, the compressor being configured to compress the lower temperature CO2 gas stream from the at least one heat exchanger and output a compressed CO2 gas stream through a sixth outlet, the sixth outlet being fluidly coupled to the filter box.

In addition to one or more of the features described herein, or as an alternative, further embodiments of the system may include wherein the filter box includes a fourth inlet fluidly coupled to the sixth outlet, the mixing plenum being thermally coupled to the compressed CO2 gas stream.

In addition to one or more of the features described herein, or as an alternative, further embodiments of the system may include wherein the filter box includes a seventh outlet that is fluidly coupled to the combustor.

In addition to one or more of the features described herein, or as an alternative, further embodiments of the system may include wherein the combustor includes a pressure vessel having a combustion chamber disposed therein, the pressure vessel and combustion chamber defining a space therebetween, the space being fluidly coupled between the seventh outlet and the recuperator.

In addition to one or more of the features described herein, or as an alternative, further embodiments of the system may include a conduit fluidly coupled to transfer a cooled expanded gas between the recuperator and a combustion chamber inlet.

In addition to one or more of the features described herein, or as an alternative, further embodiments of the system may include a fuel feed assembly having a pressurized hopper operably coupled to flow pressurized fuel to the conduit.

In addition to one or more of the features described herein, or as an alternative, further embodiments of the system may include wherein the fuel feed assembly further includes a first valve coupled to an inlet of the pressurized hopper, a second valve coupled to an outlet of the pressurized hopper, and a third valve fluidly coupled between a pressurized gas source and the pressurized hopper.

In addition to one or more of the features described herein, or as an alternative, further embodiments of the system may include a controller having at least one processor, the at least one processor being operable to execute computer instructions to open the first valve to flow fuel into the pressurized hopper, to close the first valve when the fuel level reaches a predetermined level, and to open the third valve to pressurize the pressurized hopper in response to the closing of the first valve.

In addition to one or more of the features described herein, or as an alternative, further embodiments of the system may include a feed passage fluidly coupled to the first valve, wherein the third valve is further fluidly coupled to the passage.

In addition to one or more of the features described herein, or as an alternative, further embodiments of the system may include wherein the at least one heat exchanger comprises a first heat exchanger and a second heat exchanger fluidly coupled in series.

In addition to one or more of the features described herein, or as an alternative, further embodiments of the system may include an air-separation unit fluidly coupled to supply oxygen to the second heat exchanger.

In addition to one or more of the features described herein, or as an alternative, further embodiments of the system may include wherein the air-separation unit is a cryogenic device that generates liquid oxygen.

In addition to one or more of the features described herein, or as an alternative, further embodiments of the system may include wherein the temperature of the lower temperature CO2 is about -25° C.

According to another aspect of the disclosure, a method is provided comprising mixing an organic fuel with a CO2 gas stream to generate a fuel-CO2 gas, combusting the fuel-CO2 gas in a combustor and generating a combustion gas, filtering the combustion gas to form a clean combustion gas, compressing a CO2 gas in a compressor to generate pressurized CO2 gas, reducing the temperature of the clean combustion gas by flowing the pressurized CO2 gas to a mixing plenum, and expanding the clean combustion gas in an expansion turbine to generate expanded clean combustion gas, with the expansion turbine being operably coupled to the compressor. The method futher includes flowing the expanded clean combustion gas to a recuperator, flowing the pressurized CO2 gas from the mixing plenum to the recuperator, and transferring thermal energy from the expanded clean combustion gas to generate the CO2 gas stream and a reduced temperature clean combustion gas stream. Additionally, the method involves removing thermal energy from the reduced temperature clean combustion gas stream in at least one heat exchanger, and flowing the reduced temperature clean combustion gas stream to the compressor.

In addition to one or more of the features described herein, or as an alternative, further embodiments of the method may include generating oxygen with an air separation unit thermally coupled to the at least one heat exchanger.

In addition to one or more of the features described herein, or as an alternative, further embodiments of the method may include wherein the air separation unit is a cryogenic air separation unit that generates liquid oxygen.

In addition to one or more of the features described herein, or as an alternative, further embodiments of the method may include transferring the organic fuel from a first hopper to a second hopper, the first hopper being at atmospheric pressure.

In addition to one or more of the features described herein, or as an alternative, further embodiments of the method may include sealing the second hopper and pressurizing the second hopper to a predetermined pressure level.

In addition to one or more of the features described herein, or as an alternative, further embodiments of the method may include wherein the predetermined pressure level is at or above the CO2 gas stream.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1A is a schematic illustration of a combined heat and power system in accordance with an embodiment;

FIG. 1B is a schematic illustration of a control system for the system of FIG. 1A;

FIG. 2 is a schematic illustration of feed assembly for the system of FIG. 1A in accordance with an embodiment; and

FIG. 3 is a schematic illustration of a combustion portion of the system of FIG. 1A.

The detailed description explains embodiments of the disclosure, together with advantages and features, by way of example with reference to the drawings.

### DETAILED DESCRIPTION OF THE INVENTION

Embodiments of the present disclosure are directed to a power system having a direct, oxygen/solid organic fired, closed, recuperated, sub critical pressure carbon dioxide (CO2) Brayton cycle. In this system solid organic fuel is combusted at pressure inside a combustion chamber utilizing high-purity oxygen (93 %-99.5 % O2) as the oxidizer. In some embodiments, oxygen is provided by an air separation unit which can be produced via pressure swing adsorption or cryogenic methods. Cryogenic O2 production has advantages of higher purity and provides a cold sink to absorb waste heat from the cycle and cool the working gas to very cold temperatures as low as -25C. As used herein, a sub critical pressure CO2 Brayton cycle has a pressure of less than 1100 psi. In other embodiments, the CO2 Brayton cycle has a pressure of less than or equal to 200 psi.

Further embodiments of the present disclosure provide for a system that is a closed loop using CO2 as the working fluid for the turbine and the heat transfer fluid to carry the heat from the combustion chamber to the turbine. CO2 gas coming from the compression turbine is routed through the pressure vessels housing the filter box and combustion chambers. The gas is then routed to a recuperator to preheat the gas. The pre heated gas is partially routed through the combustion chamber where the oxygen and the solid fuel are combusted to generate hot combustion gases. The hot combustion gases comprising mostly CO2 is then routed into a filter box where particles are separated out of the working gas stream.

The top of the filter box includes a mixing plenum where the clean hot gas is mixed with a portion of the cooler compressor gas to reduce the temperature of the working gas to a predetermined setpoint temperature of the expansion turbine. The pressurized, reduced temperature working gas flows to the expansion turbine where the gas is expanded. The expanded gas leaving the expansion turbine is routed to a recuperator where the heat/thermal energy is transferred to the compressed CO2 gas from the compressor. The expanded gas leaving the recuperator is at a lower temperature but still has usable heat for thermal applications such as second cycle or absorption cooling or other thermal uses. The expanded gas is then cooled first by a high temperature heat exchanger to utilize this heat for high temperature applications and then a low temperature heat exchanger to recover waste heat back into the cycle via the liquid O2 from the air separation unit before going to the inlet of the compressor. In some embodiments, the cooling of the exhaust gas can be achieved with a water-cooled heat exchanger to approach atmospheric temperature or by using the heat in an absorption chilling cycle to cool the exhaust gas to 0 degrees C or lower.

The fuel is comprised of solid organic material that consists of many types of organics including but not limited to biomass, food waste, paper, plastics and other materials containing carbon and/or hydrogen. It is desirable to use organic materials that do not contain halogens, heavy metals, sulfur or other toxic elements as this could cause the need for gas cleaning of these contaminants. The solid organics are fed, under pressure, into the inlet of the combustion chamber by a metering auger that delivers the fuel at a controlled set point. The fuel drops down a conduit/pipe and combines with the high flow of compressed preheated gas and is carried into the inner combustion chamber. Positioned vertically above the metering auger is a pressurized sub hopper which functions to store fuel for a short period of time. Vertically above and below the sub hopper are valves which can isolate the sub hopper under pressure or depressurize the sub hopper when filling with fuel. The sub hopper is filled at atmospheric pressure by an external auger that is connected to the large fuel storage hopper. In an embodiment, a fuel level sensor at the bottom of the sub hopper controls the bottom valve to close and then depressurizes the gas in the sub hopper. The gas from the sub hopper is directed to the external auger and storage hopper to displace air that enters the hopper during filling.

Once the sub hopper is depressurized the top valve opens and the hopper is filled by the external auger until a top-level sensor is reached. The top valve then closes and the sub hopper is re-pressurized with cooled CO2 gas from the compressor. Once the sub hopper reaches the same pressure as the combustion chamber the bottom valve opens allowing fuel to drop down (under the influence of gravity) into the metering auger. The large external storage hopper includes a lid that can be closed after filling with solid fuel and has a vent to allow air and CO2 to exit the hopper. During operation CO2 gas that is vented from the sub hopper flows through the external auger into the large storage hopper. The CO2 is heavier than air so air will be displaced towards the top of the hopper where it is vented. In some embodiments, the CO2 completely displaces all the air and then CO2 is vented out of the storage hopper.

As organic material is oxidized into CO2 and water, the additional mass would increase the pressure of the system. A pressure control valve is located on the low-pressure side of the system and is used to set the lower or minimum operating pressure of the system. As pressure increases due to additional mass, the control valve allows cooled CO2 gas to exit the system. This maintains a constant average pressure in the system while extracting the excess CO2. The gas leaving the system is substantially CO2 (>92 %) with trace amounts of CO, water and other contaminants which are then removed through subsequent processing to produce pure CO2 for reuse, conversion or sequestration.

The present system provides many advantages including the use of an oxy-fuel combustion system to oxidize the solid organics. This reduces or eliminates the nitrogen from the system, provides a byproduct of CO2 which is used as the working gas and reduces or eliminates the need to separate CO2 from the exhaust gas that would normally be mixed with air.

One advantage in using CO2 for the working gas instead of air is, at atmospheric pressure and temperature, CO2 is 60 % denser than air. Since there is no change in volume flow through the system the added density represents a 60 % increase in mass flow resulting in 60 % more power for the same equipment.

Another advantage of the present system is that the heat capacity ratio (Cp/Cv) for CO2 is lower than air. This means for the same pressure ratio the differential temperature across the compressor and expander is lower for CO2 than air. This results in a higher differential temperature across the recuperator and in turn higher thermo-electric efficiency over air for the same T hot and T cold temperatures.

Another advantage of the present system is that by using oxygen, the oxygen/fuel ratio can be controlled independently from the turbine speed and power. This allows for more complete combustion over a wider range of operating conditions such as with part-load conditions.

Another advantage is the exhaust output is captured CO2 and condensed water. This reduces the need for or eliminates the exhaust stack associated with air cycle power systems and in turn reduces the need for or eliminates the requirement to permit the power system for emissions.

Another advantage of the present system is that the gas output is nearly pure CO2 (>92 %) and uses a reduced amount of post processing to make the CO2 useable for secondary use such as welding gas, food and beverage, dry ice, liquid CO2 or conversion into many other carbon products.

Operation of the CHP system begins with starting the turbine at a desired lower speed, such as 20 % full speed for example. The valve from the turbine to the mixing plenum is closed, which directs all the flow to the combustion chamber. Ignition begins with a gaseous fuel (methane, propane, syngas) fed to an oxy-fuel burner. Oxygen gas is being supplied by an air separation unit. The burner delivers heat to the flowing gas to increase the temperature of the system. As the combustion temperature rises the turbine speed is increased to maintain the differential temperature across the first heat exchanger within limits. When the temperature in the combustion chamber reaches the desired temperature, such as 600C for example, solid fuel is fed into the combustion chamber and the gaseous fuel is turned off. Oxygen continues to be fed proportional to the solid fuel to maintain a desired oxygen/fuel ratio for stoichiometric combustion. Fuel and oxygen rate are increased to increase system temperature. When the combustion chamber reaches a desired operating temperature, such as 925C for example, the valve to the mixing plenum begins to open. A temperature sensor located on the turbine inlet and connected to the plenum valve, controls the temperature of the gas leaving the mixing plenum. The temperature of the combustion chamber continues to rise until reaching a desired temperature, such as >1000C for example, to provide a desired level of combustion efficiency. A temperature sensor at the outlet of the combustion chamber and connected to the fuel feed system auger, controls the combustion chamber temperature. As the temperature rises to the operating temperature the turbine speed increases to maximum speed and power. Once operating temperatures are reached, power is controlled by torque control of the generator and by modulating the fuel feed and oxygen rate into the combustion chamber.

In still further embodiments, one or more embodiments are provided that are a combined heat and power system, utilizing waste organic resources and converting it into heat energy used to drive a gas turbine coupled to the thermal system to produce power and a high level of usable waste heat for both low and high temperature thermal applications.

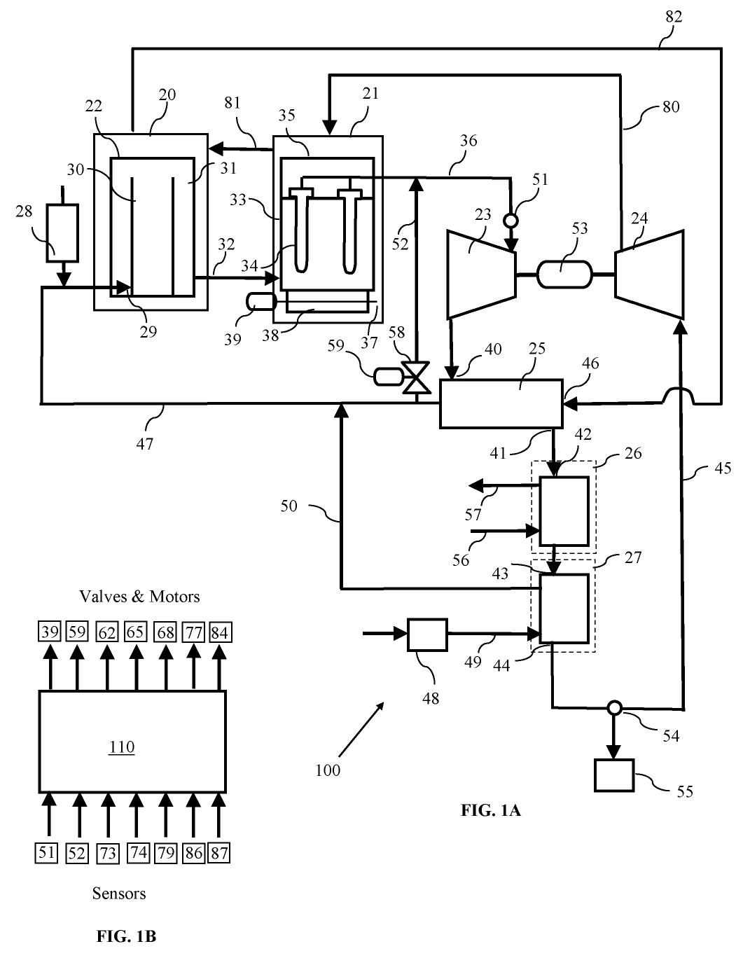

Referring now to FIG. 1A, an embodiment is shown of a direct fired combined heat and power system 100. The system 100 includes a combustor 20 having a combustion chamber 22. The combustion chamber 22 includes an inner section 30 and outer section 31 and are disposed within an outer housing 20 that forms a pressure vessel about the combustion chamber. The combustion chamber 22 further includes an inlet 29 that receives a gas fuel mixture. In an embodiment, the gas is at least 85 % CO2. In an embodiment, gas and fuel flow into the inner portion 30 tangentially and the products flow upward while combusting and then downward through an outer portion 31 before exiting the pressure vessel. An outlet 32 in the combustion chamber allows hot combustion gas to flow to a filter box 21.

The filter box 21 includes a plurality of filters 34 that remove particulate from the hot combustion gases. An ash plenum 38 having an auger 37 that is driven by a motor 39 removes the filtered ash particulate from the filter box 21. The ash particulates are removed from the pressurized filter box through a gas lock as described in FIG. 3. The top side of the filter box 21 includes a mixing plenum 35 that allows the clean hot combustion gas to mix with (relatively) cooler compressor gas from the compressor 24, via recuperator 25 to a predetermined set point temperature. In an embodiment, the set point temperature of the gas flowing in conduit 36 is determined by the operating parameters of an expansion turbine 23. In an embodiment, the set point temperature is about 925C. In another embodiment, the set point temperature is about 1025C. A temperature sensor 51 measures the temperature of the filter box gas in conduit 36 prior to the gas entering the expansion turbine 23. The temperature signal is an input to a controller 110 which adjusts the flow of gas along conduit 52 from the compressor turbine 24. The temperature signal may be used with control algorithms to adjust the operation of valve 58, such as with motor 59 for example, to flow additional cooler gas along conduit 52 to mix with the gas of conduit 36. In other embodiments, the conduit 52 connects to the filter plenum 35.

Expanded gas from the expansion turbine 23 flows to a recuperator 25 where thermal energy is transferred to compressed CO2 gas from the compressor 24 to pre-heat the CO2 gas prior to the combustion chamber 22. The expanded gas leaving the recuperator 25 flows along a conduit 42 to a high temperature heat exchanger 26 having an inlet 56 and an outlet 57 that are used to absorb thermal energy from the expanded gas from the recuperator. In an embodiment, the high temperature heat exchanger cools the expanded gas from about 250C to about 70C. The inlet 56 and outlet 57 may be connected to other high temperature applications such as water or thermal oil. The cooled expanded gas flows from the high temperature heat exchanger 26 to a low temperature heat exchanger 27. The low temperature heat exchanger 27, recovers waste heat back into the cycle via liquid oxygen (O2) from an oxygen source, such as air separation unit 48 for example, that flows the liquid O2 via conduit 49 to the low temperature heat exchanger 27. Liquid O2 is vaporized and heated in heat exchanger 27.

In an embodiment, a conduit 50 transfers oxygen from the low temperature heat exchanger 27 to conduit 47 to mix with the solid fuel and pre-heated CO2 gas.

A first output from the low temperature heat exchanger 27 flows through the conduit 45 back to the compressor turbine 24. In an embodiment a control valve 54 receives the low temperature low pressure CO2 gas stream from the low temperature heat exchanger 27. The control valve 54 is configured to maintain a predetermined constant pressure within the system 100 by selectively diverting a portion of the CO2 gas stream to an external process 55. In an embodiment, the predetermined constant pressure would be equal to or greater than atmospheric pressure. In another embodiment, the predetermined constant pressure is based at least in part on the operating temperature limits of components on the high pressure side of the system. In an embodiment, the external process 55 receives the CO2 gas stream, which is substantially CO2 with trace amounts of water and other contaminants, for further processing. In one embodiment, the extracted CO2 gas stream is filtered to remove the water and contaminants to a desired level. Then the substantially pure (e.g. 99.9 %) CO2 gas may be reused, converted or sequestered for example.

A second output from the low temperature heat exchanger 27 flows a relatively high temperature high pressure O2 gas through conduit 50 back to conduit 47 where it is mixed with the output of the recuperator 25. The combined gas flow is mixed with an output from the feed system 28 and transferred to the combustion chamber 22.

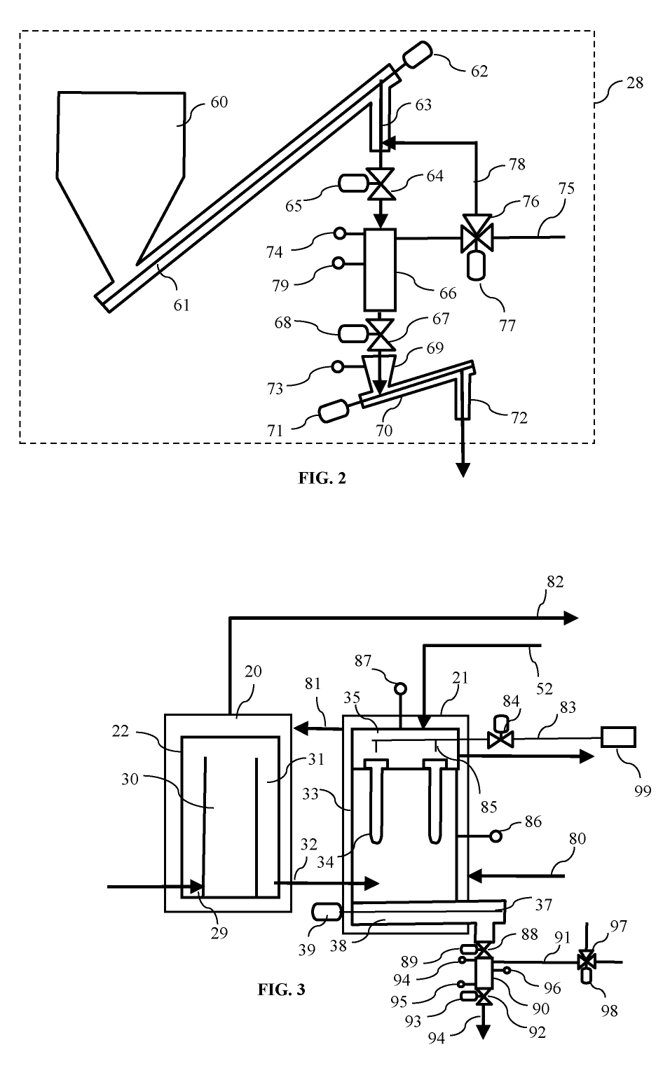

Referring now to FIG. 2, an embodiment is shown of the fuel feeding assembly 28. In this embodiment, the assembly 28 includes a fuel hopper 60 that is configured to receive an organic solid fuel material at ambient pressure. In an embodiment, the fuel may include biomass fuels, that is, organic materials include, for example, woody fuels such as wood chips, saw grass, and the like, animal wastes, i.e., manures, non-halogenated plastics or even municipal solid waste (MSW). The hopper 60 includes an exit port that is in fluid communication with an auger 61 that transfers the fuel along a delivery chute. The auger 61 is driven by a motor 62 that is communicatively coupled to the controller 110. The auger 61 transfers the fuel to a vertical passage 63.

A control valve 64 is in communication with the passage 63 and controls the flow of fuel into a secondary hopper 66. The control valve 64 is operably coupled to actuate the control valve 64 in response to a signal from the control 110. It should be appreciated that since the conduit 47 is pressurized, it is desirable to have the fuel injected into the gas stream at a pressure above ambient pressure. In an embodiment, the fuel is injected into the gas stream of conduit 47 at substantially a pressure that is the same as or greater than the gas stream.

To achieve a pressurized state, the inlet and outlet of secondary hopper 66 are controlled by valves 64, 67 and 76. Control valve 64 is activated by a motor 68 that is actuated by a signal from the controller 110. The valves 64, 67 can be selectively closed and the secondary hopper 66 pressurized with gas from a three-way control valve 76. Three-way valve 76 receives an input gas from conduit 75 which comes from cooled compressor gas off conduit 80 and selectively flows the gas to the passage 63 or the secondary hopper 66. In operation, the valve 64 is opened and the valve 67 is closed. This allows fuel to flow from the passage 63 into the secondary hopper 66. When the secondary hopper is filled to a desired level, sensor 74 sends a signal to stop the feed auger 61 and close valve 64 stopping the flow of fuel. The three-way valve 76 is configured to flow pressurized gas to the secondary hopper 66 to pressurize the fuel. When a desired pressure is achieved, sensor 79 sends a signal to open valve 67, allowing the pressurized fuel to transfer (e.g. on the influence of gravity) into a channel 69 that directs the pressurized fuel into an auger 70 that is driven by a motor 71. The auger moves the pressurized fuel to a vertical passage 72 that is in communication with conduit 47. It should further be appreciated that the three-way valve 76 may further be used to depressurize the secondary hopper 66 prior to opening the valve 64 and flowing additional fuel to the secondary hopper.

It should be appreciated that the assembly 28 may include a number of sensors that provide feedback signals to the controller 110. These sensors may include a fuel level sensor 74 and pressure sensor 79 that are operably coupled to the secondary hopper 66. The assembly may further include a level sensor 73 positioned on the channel 69. In an embodiment, the level sensor 73 provides a signal to the controller 110 to close valve 67 and signal valve 76 to depressurize hopper 66. The sensors 73, 74, 79 provide signals to the controller 110 which uses the data in the execution of control functions to control the operation of the assembly 28 and the system 100. For example, when the secondary hopper 66 is being filled with fuel via valve 64, the level sensor 74 transmits either a signal representing the level of the fuel within the secondary hopper, or transmits a signal when the fuel level reaches a predetermined amount.

Referring now to FIG. 3, an embodiment is shown of a portion of the system 100 that includes the combustor 20 and filter box 21. In this embodiment, the filter box 21 includes sensors 86 and 87, such as a pressure sensor for example, that measures the differential pressure across the filter element 34. In this embodiment, the filter box 21 further includes a pressure sensor 86 and a pressure sensor 87, The sensors 86, 87 are used to allow the controller 110 to determine a pressure differential and selectively actuate valve 84 in response to a threshold being reached. This pressure differential is variable based on the ash cake composition on the filter. When the valve 84 opens, a short (e.g. approximately 200 millisecond) pulse of CO2 is directed through ports 85 and down the filter. In an embodiment, the CO2 pulse is delivered at 3-4 bar above the filter box 21 pressure. The pressurized CO2 may be provided by a booster compressor 99 that is fluidly coupled to the turbine compressor via conduit 80. This provides a technical effect of breaking the ash cake composition from the filter with a reverse or counter-flow CO2. The ash drops off the filter 34 into the ash plenum 38 where the ash is removed from the filter box 21 by the ash auger 37. During operation the ash drops under the influence of gravity into a sub hopper 90. Valve 88 is open and valve 92 is closed allowing sub hopper 90 to be pressurized while the ash is filling the sub hopper 92. A sensor 94 senses when the hopper is full and sends a signal to controller 110 to close valve 88 by the actuator 89. Valve 97 is a three-way valve that depressurizes sub hopper 90 and vents the CO2 gas. When the sub hopper is atmospheric or set to the low pressure setting of system 100, valve 92 opens by actuator 93 to allow the ash to be removed from the pressurized section of the system. Sensor 95 senses when the sub hopper is empty and sends a signal to controller 110 to close valve 92 and direct compressor gas through valve 97 to pressurize sub hopper 90. Sensor 96 senses the pressure inside sub hopper 90 and sends a signal to controller 110. When the pressure of the sub hopper 90 is equal to or above the filter box 20 pressure, controller 110 then sends a signal to open valve 88 by actuator 89 and allow ash to flow into sub hopper 90.

In an embodiment, the system 100 may include a controller 110 as is shown in FIG. 1B. The controller 110 includes one or more processors responsive to executable instructions to execute control methods to either vary system 100 parameters, such as valve 58 for example, in response to inputs, such as temperature sensor 51 for example, to change the operation of the system 100 or to achieve a desired state of operation.

It should be appreciated that while a single controller module is illustrated in FIG. 1B, it is contemplated that the control functionality described herein may be accomplished by a single or multiple controllers or microprocessors without departing from the present intention. The use of multiple hardware controllers may in some instances be desired since it would allow the use of self-checking or so called “watch-dog” algorithms to detect hardware malfunctions within the system 100. The use of multiple hardware controllers may also be advantageous where the components of the system 100 are physically separated from each other. In an embodiment where either a single controller or multiple controllers are used, the controller 110 is a suitable electronic device capable of accepting data and instructions, executing the instructions to process the data, and presenting, logging, or transmitting the results. Controller 110 may accept instructions or display information through user interface, or through other means such as but not limited to electronic data card, voice activation means, manually-operable selection and control means, radiated wavelength and electronic or electrical transfer. Therefore, controller 110 can be a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a superconducting computer, a supercomputer, a solid-state computer, a single-board computer, a buffered computer, a computer network, a desktop computer, a laptop computer, a scientific computer, a scientific calculator, or a hybrid of any of the foregoing.

Controller 110 is capable of converting the analog voltage or current level provided by an external device such as sensors 51, 52, 73, 74, 79, 86, 87, 94, 95, 96 into a digital signal indicative of the operating state within the system 100, or a communication from another controller. Alternatively, the external device (e.g. sensors 51, 52, 73, 74, 79, 86, 87, 94, 95, 96) may be configured to provide a digital signal to controller 110, or an analog-to-digital (A/D) converter (not shown) maybe coupled between an external device and controller 110 to convert the analog signal provided by external device into a digital signal for processing by controller 110. Controller 110 uses the digital signals act as input to various processes for controlling aspects of the system 100 operation. The digital signals may represent one or more system 100 data including but not limited to temperatures, pressures, fuel levels, and the like.

Controller 110 is operably coupled with one or more components of system 100 by data transmission media. Data transmission media includes, but is not limited to, twisted pair wiring, coaxial cable, and fiber optic cable. Data transmission media also includes, but is not limited to, wireless, radio and infrared signal transmission systems. Controller 110 is configured to provide operating signals to these components and to receive data from these components via data transmission media.

Controller 110 includes operation control methods embodied in application code. These methods are embodied in computer instructions written to be executed by at least one processor, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, Visual C++, Java, ALGOL (algorithmic language), BASIC (beginners all-purpose symbolic instruction code), visual BASIC, ActiveX, HTML (HyperText Markup Language), and any combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It should also be noted that the terms “first”, “second”, “third”, “upper”, “lower”, and the like may be used herein to modify various elements. These modifiers do not imply a spatial, sequential, or hierarchical order to the modified elements unless specifically stated.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ± 8 % or 5 %, or 2 % of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A combined heat and power system comprising:
a combustor configured to receive and combust a solid fuel and gas mixture, the combustor having a first outlet that flows combustion gas from the combustor, the gas mixture being at least 85% CO2;
a filter box having a first inlet fluidly coupled to the first outlet, the filter box having at least one filter member fluidly coupled to the first inlet and a mixing plenum fluidly coupled to the at least one filter member opposite the first inlet, the filter box having a second outlet;
an expansion turbine having a second inlet fluidly coupled to the second outlet, the expansion turbine being configured to receive a flow of filtered gas from the filter box and generate work based at least in part on an expansion of the filtered gas and output a lower pressure gas through a third outlet;
a recuperator fluidly coupled to the third outlet, the recuperator being configured to transfer thermal energy from the lower pressure gas from the expansion turbine to a carbon dioxide (CO2) gas stream, the recuperator having a fourth outlet;
at least one heat exchanger fluidly coupled to the fourth outlet, the at least one heat exchanger being configured to reduce the temperature of the CO2 gas stream received from the recuperator and output a lower temperature CO2 gas stream through a fifth outlet;
a compressor rotationally coupled to the expansion turbine, the compressor having a third inlet fluidly coupled to the fifth outlet, the compressor being configured to compress the lower temperature CO2 gas stream from the at least one heat exchanger and output a compressed CO2 gas stream through a sixth outlet, the sixth outlet being fluidly coupled to the filter box.

2. The system of claim 1, wherein the filter box includes a fourth inlet fluidly coupled to the sixth outlet, the mixing plenum being thermally coupled to the compressed CO2 gas stream.

3. The system of claim 2, wherein the filter box includes a seventh outlet that is fluidly coupled to the combustor.

4. The system of claim 3, wherein the combustor includes a pressure vessel having a combustion chamber disposed therein, the pressure vessel and combustion chamber defining a space therebetween, the space being fluidly coupled between the seventh outlet and the recuperator.

5. The system of claim 1, further comprising a conduit fluidly coupled to transfer a cooled expanded gas between the recuperator and a combustion chamber inlet.

6. The system of claim 5, further comprising a fuel feed assembly having a pressurized hopper operably coupled to flow pressurized fuel to the conduit.

7. The system of claim 6, wherein the fuel feed assembly further includes a first valve coupled to an inlet of the pressurized hopper, a second valve coupled to an outlet of the pressurized hopper, and a third valve fluidly coupled between a pressurized gas source the pressurized hopper.

8. The system of claim 7, further comprising a controller having at least one processor, the at least one processor being operable to executable computer instructions to open the first valve to flow fuel into the pressurized hopper, to close the first valve when the fuel level reaches a predetermined level, and to open the third valve to pressurize the pressurized hopper in response to the closing of the first valve.

9. The system of claim 8, further comprising a feed passage fluidly coupled to the first valve, wherein the third valve is further fluidly coupled to the passage.

10. The system of claim 1, wherein the at least one heat exchanger comprises a first heat exchanger and a second heat exchanger fluidly coupled in series.

11. The system of claim 10, further comprising an air-separation unit fluidly coupled to supply oxygen to the second heat exchanger.

12. The system of claim 11, wherein the air-separation unit is a cryogenic device that generates liquid oxygen.

13. The system of claim 12, wherein the temperature of the lower temperature CO2 is about -25C.

14. A method comprising:
mixing an organic fuel with a CO2 gas stream to generate a fuel-CO2 gas;
combusting the fuel-CO2 gas in a combustor and generating a combustion gas;
filtering the combustion gas to form a clean combustion gas;
compressing a CO2 gas in a compressor to generate pressurized CO2 gas;
reducing the temperature of the clean combustion gas by flowing the pressurized CO2 gas to a mixing plenum;
expanding the clean combustion gas in an expansion turbine to generate expanded clean combustion gas, the expansion turbine being operably coupled to the compressor;
flowing the expanded clean combustion gas to a recuperator;
flowing the pressurized CO2 gas from the mixing plenum to the recuperator and transferring thermal energy from the expanded clean combustion gas to generate the CO2 gas stream and a reduced temperature clean combustion gas stream;
removing thermal energy from the reduced temperature clean combustion gas stream in at least one heat exchanger; and
flowing the reduced temperature clean combustion gas stream to the compressor.

15. The method of claim 14, further comprising generating oxygen with an air separation unit thermally coupled to the at least one heat exchanger.

16. The method of claim 15, wherein the air separation unit is a cryogenic air separation unit that generates liquid oxygen.

17. The method of claim 14, further comprising transferring the organic fuel from a first hopper to a second hopper, the first hopper being at atmospheric pressure.

18. The method of claim 17, further comprising sealing the second hopper and pressurizing the second hopper to a predetermined pressure level.

19. The method of claim 18, wherein the predetermined pressure level is at or above the CO2 gas stream.

20. A combined heat and power system comprising:
a combustor configured to receive and combust a solid fuel and gas mixture, the combustor having a first outlet that flows combustion gas from the combustor, the gas mixture being at least 85% CO2;
a filter box having a first inlet fluidly coupled to the first outlet, the filter box having at least one filter member fluidly coupled to the first inlet and a mixing plenum fluidly coupled to the at least one filter member opposite the first inlet, the filter box having a second outlet;
an expansion turbine having a second inlet fluidly coupled to the second outlet, the expansion turbine being configured to receive a flow of filtered gas from the filter box and generate work based at least in part on an expansion of the filtered gas and output a lower pressure gas through a third outlet;
a recuperator fluidly coupled to the third outlet, the recuperator being configured to transfer thermal energy from the lower pressure gas from the expansion turbine to a carbon dioxide (CO2) gas stream, the recuperator having a fourth outlet;
at least one heat exchanger fluidly coupled to the fourth outlet, the at least one heat exchanger being configured to reduce the temperature of the CO2 gas stream received from the recuperator and output a lower temperature CO2 gas stream through a fifth outlet;
an oxygen source fluidly coupled to supply oxygen to the at least one heat exchanger; and
a compressor rotationally coupled to the expansion turbine, the compressor having a third inlet fluidly coupled to the fifth outlet, the compressor being configured to compress the lower temperature CO2 gas stream from the at least one heat exchanger and output a compressed CO2 gas stream through a sixth outlet, the sixth outlet being fluidly coupled to the filter box.
